(19) United States
(12) Patent Application Publication
(10) Pub. No.: US 2003/0048566 A1
(43) Pub. Date: Mar. 13, 2003

(54) Contoured disc drive head surface and method

(75) Inventor: Serge Jacques Fayeulle, Longmont, CO (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/028,496

(22) Filed: Dec. 20, 2001

Related U.S. Application Data
(60) Provisional application No. 60/318,898, filed on Sep. 11, 2001.

(51) Int. Cl. G11B 21/02; G11B 15/46

(52) U.S. Cl. 360/75; 360/73.03

(57) ABSTRACT

A method of contouring a surface portion of a head for a disc drive includes positioning the head over a park zone of a disc and rotating the disc while maintaining the head positioned substantially over the park zone to produce a contour on the surface portion of the head. A disc drive includes a disc rotatably mounted on a spindle motor mounted on a base and an actuator assembly mounted adjacent the disc, the actuator assembly having an actuator arm including a distal end supporting a head over a surface of the disc. The head includes a head surface portion facing the disc surface, wherein the head surface portion has been contoured by positioning the head over a park zone on the disc and maintaining the head positioned substantially over the park zone of the disc while rotating the disc for a selected time so as to burnish the head surface portion.

### RELATED APPLICATIONS

This application claims priority of U.S. provisional application Serial No. 60/318,898, filed Sep. 11, 2001.

### FIELD OF THE INVENTION

This application relates generally to disc drives and more particularly to a contoured surface of a head in a disc drive to prevent the head from contacting the data portion of the disc surface during use.

### BACKGROUND OF THE INVENTION

A disc drive typically includes one or more discs that rotate at a constant high speed during operation of the drive. Information is written to and read from tracks on the discs through the use of an actuator assembly, which rotates during a seek operation. A typical actuator assembly includes a plurality of actuator arms, which extend towards the discs, with one or more flexures extending from each of the actuator arms. Mounted at the distal end of each of the flexures is a head, which acts as an air bearing slider enabling the head to fly in close proximity above the corresponding surface of the associated disc. In contact start/stop drives, each head lands on and takes off from a delimited area of the disc. This area (the park zone) is typically textured in order to limit stiction. The texture is typically comprised of laser-formed bumps, which are typically about 100 Angstroms high. Each head includes contact pads that are designed to contact the park zone during landing and take off. Additionally, some or all of the contact pads are designed to be the first part of the head that will contact the disc surface if the head inadvertently contacts the data portion of the disc during operation. The contact pads thereby prevent other parts of the head, such as the transducer, from being damaged by or causing damage to the disc surface.

Increasing the density of information stored on discs can increase the storage capacity of hard disc drives. To read the densely stored information, designers have decreased the gap fly height between the heads and the discs. Reducing the gap fly height can lead to increased contact between the head and the data portion of the disc, causing unacceptable read/write errors. Accordingly there is a need for an improved head that prevents contact between the head and the data portion of the disc surface. The present invention provides a solution to this and other problems, and offers other advantages over the prior art.

### SUMMARY OF THE INVENTION

Against this backdrop the present invention has been developed. One embodiment of the present invention is a method of contouring a surface portion of a head for a disc drive that includes a disc rotatably mounted on a base. The method includes positioning the head over a park zone of the disc and rotating the disc for a selected time to burnish the head against the park zone of the disc while maintaining the head positioned substantially over the park zone.

Another embodiment of the present invention is a disc drive including a rotating disc and an actuator assembly mounted adjacent the disc, the actuator assembly having an actuator arm including a distal end supporting a head over a surface of the disc. The head includes a head surface portion facing the disc surface, wherein the head surface portion has been contoured by positioning the head over a park zone on the disc and maintaining the head positioned substantially over the park zone of the disc while rotating the disc for a selected time so as to burnish the head surface portion.

An embodiment of the present invention may also be summarized as a method of contouring a surface portion of a head for a disc drive. The method includes positioning the head over a park zone of a rotating disc and contouring the head surface portion to reduce contact between the head and the disc during operation of the disc drive.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention with a portion of the top cover broken away to show the primary internal components.

FIG. 2 is a perspective view of a head according to a preferred embodiment of the present invention.

FIG. 3 is a flowchart of a method of contouring a surface portion of the head of FIG. 2 in accordance with a preferred embodiment of the present invention.

FIG. 4 is a flowchart depicting a preferred embodiment of the rotate disc step of FIG. 3 in more detail.

FIG. 5 is a chart depicting the contour of a surface portion of a head before subjecting the surface portion to the contouring method of FIG. 3.

FIG. 6 is a chart depicting the contour of a surface portion of a head after subjecting the surface portion to the contouring method of FIG. 3.

### DETAILED DESCRIPTION

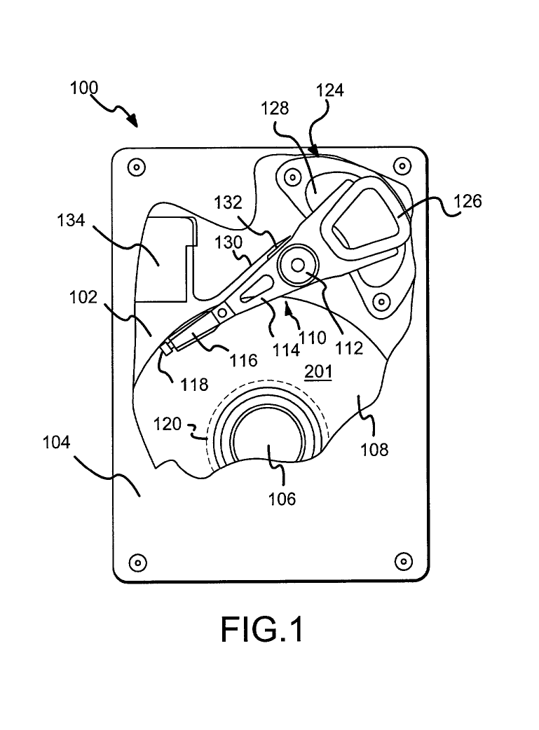

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which acts as an air bearing slider enabling the head 118 to fly in close proximity above the corresponding surface of the associated disc 108.

During a seek operation, the track position of the heads 118 is controlled through the use of a voice coil motor 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 such as near the inner diameter of the discs 108 when the drive motor is de-energized. The heads 118 can be secured over the park zones 120 through the use of an actuator latch arrangement, which prevents inadvertent rotation of the actuator assembly 110 when the heads are parked. Park zones 120 preferably are textured to form bumps that prevent stiction between each park zone 120 and the corresponding head 118 when the head 118 is in contact with the park zone 120. Directed laser light preferably forms the bumps in the park zones 120.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

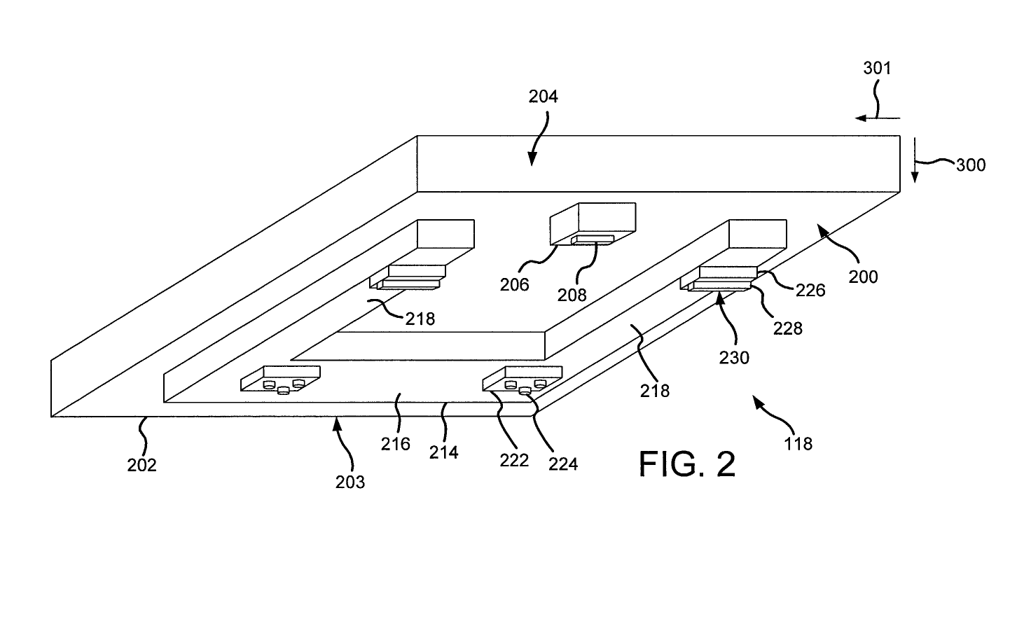

FIG. 2 depicts the underside 200 of a head 118 that faces a corresponding surface 201 of the disc 108 (see FIG. 1). The head 118 shown in FIG. 2 is a conventional head design, but the scope of the invention includes other head designs. Orientation terms such as “under”, “down”, and “up” are used for convenience, but the head 118 can be oriented in many different ways so long as it is appropriately oriented relative to the corresponding disc surface 201 (see FIG. 1). The head 118 is preferably comprised of conventional materials and formed according to known manufacturing methods.

The head 118 includes a body 202, which may be any of various known shapes, but is shown in FIG. 2 as a rectangular block. The body 202 defines a leading edge 203 that is the first portion of the head 118 to encounter a particular section of the disc surface 201 as the disc 108 (see FIG. 1) rotates beneath the head 118. A trailing edge 204 of the body 202 faces opposite the leading edge 203. A transducer riser 206 depends from the body 202 near the trailing edge 204, and a read/write transducer 208 is mounted on the transducer riser 206 distal from the body 202.

In one preferred embodiment, a generally U-shaped rail 214 depends from the body 202. The rail 214 includes a base 216 near the leading edge 203 and arms 218 extending rearward from opposing sides of the base 216 so that the U-shaped rail 214 opens toward the transducer 208. Leading contact pad risers 222 depend from opposite ends of the base 216 of the rail 214. Leading contact pads 224 depend from the leading contact pad risers 222 toward the disc surface 201 (see FIG. 1). Near the trailing ends of the arms 218, trailing contact pad risers 226 depend from the rail 214, and trailing contact pads 228 depend from the trailing contact pad risers 226.

In the embodiment shown in FIGS. 1 and 2, the leading contact pads 224 and the trailing contact pads 228 are at approximately the same height relative to the disc surface 201 when the head 118 is resting on the disc surface 201. However, when the disc 108 rotates at such a speed that head 118 flies above the disc surface 201, the leading edge 203 flies higher than the trailing edge 204. Thus, during flight the trailing contact pads 228 are lower (i.e., closer to the disc surface 201) than the leading contact pads 224. Accordingly, if any part of the head 118 contacts the disc surface 201 during flight, it is likely that a downwardly facing surface portion 230 of one or more trailing contact pads 228 will contact surface 201.

Of course, the surface portion 230 could be the entire downwardly facing surface of the contact pad 228 or only a portion of it. Furthermore, while a particular head configuration is shown and described above, the burnishing method described below will improve the performance of heads with other configurations. For example, a head 118 could have a different number of contact pads in the front or rear. Likewise, the leading contact pads 224 could extend downwardly far enough so that a surface portion of the leading contact pads 224 would be first to contact the disc surface during flight. Indeed, the head 118 could be configured so that some surface portion other than the features shown in FIG. 2 is first to contact the disc surface. Thus, embodiments of the present invention are not limited by the particular head configuration shown in FIG. 2.

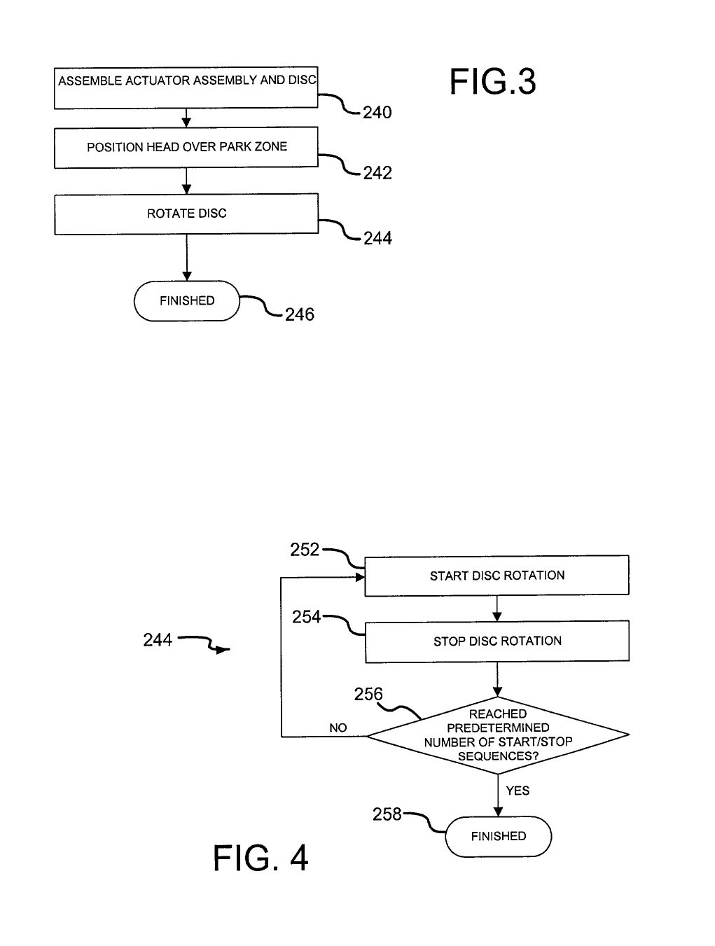

In operation, as a disc 108 rotates beneath the head 118, the head 118 flies above the disc surface 201 a predetermined distance called a gap fly height. With the decreases in fly height, it is desirable to have the contours of the pad surface portions 230 be smooth and precisely fit to the corresponding disc surface 201 so that asperities in the pad surface portions 230 do not inadvertently contact the disc surface 201 during normal operation of the disc drive 100. However, variations in the precise fit between each head 118 and disc 108 makes the prefabrication of a pad surface portion 230 that will be contoured to complement the corresponding disc surface 201 problematic. FIGS. 3 and 4 depict a preferred embodiment for contouring a surface portion of a head, such as surface portion 230, so that it is smooth and complements the corresponding disc surface 201.

Referring now to FIGS. 1-3, in step 240 the actuator assembly 110 and the disc 108 are assembled in the disc drive 100 according to known manufacturing methods. Preferably as part of the known manufacturing methods, the surface portions 230 are lapped to provide a smooth surface and they are coated through masks in accordance with known methods. In step 242 the head 118 is positioned over the park zone 120. Preferably, the head 118 is then resting with the contact pads 224 and 228 contacting the disc surface 201. In step 244 the disc is rotated while the head 118 is maintained substantially over the park zone 120. During step 244, the pad surface portions 230 are burnished by the interaction between the park zone 120 and the pad surface portions 230. This burnishing includes contact between the park zone 120 and the pad surface portions 230, but it does not necessarily include constant contact. In fact, intermittent contact may be more preferred than constant contact in some situations, such as where the rotating step 244 includes multiple starting and stopping sequences. The burnishing preferably contours the pad surface portions 230 so that they precisely fit with the complimenting surfaces of the park zone 120, according to the specific static roll and pitch attitude of the slider, and thus they also precisely fit with the remainder of the corresponding disc surface 201. When the surface portions 230 have been sufficiently burnished, the method is terminated at step 246.

Computer-executable instructions for performing the method of FIG. 3 may be included in the disc drive or may be sent to the disc drive from an external source. In a preferred embodiment, disc drive 100 includes computer executable instructions that will automatically instruct the disc drive 100 to perform the method when it is first started (i.e., during a test or burn-in phase following manufacturing and prior to shipment of the drive).

Referring now to FIGS. 1-2 and 4, a preferred embodiment of the rotating step 244 will be described in more detail. A start/stop sequence is repeated until a predetermined number of start/stop sequences have been performed. Each start/stop sequence includes starting the disc rotation at step 252, preferably so that the head 118 takes off from the park zone 120, and stopping the disc rotation at step 254, preferably so that the head 118 lands once again in the park zone 120. In step 256, the method determines whether a predetermined number of start/stop sequences have been performed. If the predetermined number of sequences has not been performed, then the method returns to step 252 and another start/stop sequence is performed. If the predetermined number of start/stop sequences has been performed, indicating that the surface portion 230 of the head 118 has been sufficiently burnished, then the method is terminated at step 258. The number of sequences should be chosen so that the surface portion 230 is sufficiently burnished to provide a smooth surface that complements the corresponding disc surface 201 without producing undue wear of the surface portion 230. From initial testing, it appears that from about 100 to about 500 start/stop sequences provides sufficient burnishing.

Notably, the method of FIGS. 3-4 is preferably performed using only existing disc drive components and does not require a separate manufacturing step. Thus, it is less expensive to perform than a method of burnishing the head 118 before mounting it in the disc drive 100. Additionally, the exact orientation of the head 118 relative to the disc drive 100 can change from one drive to another even if the drives were designed to be the same. Thus, it is believed that performing the burnishing method on the disc 108 itself with the head 118 already mounted in the disc drive accounts for the head's unique orientation by contouring the head to complement the corresponding disc surface. Although the burnishing is performed only in the park zone 120, the orientation of the head 118 with respect to the park zone 120 will be similar to its orientation with respect to the remainder of the disc surface 201. In alternative embodiments, two or more textured landing zones can be provided at various radial positions, such as the inner and outer diameter, for burnishing the head 118 at multiple disc locations. The smoothing and contouring that result from the burnishing method help to prevent contact between the head 118 and the disc 108 during subsequent normal operation of the disc drive 100.

To demonstrate the results of the method of FIGS. 3-4 on disc drive performance, a new head 118 was tested for 100 cycles. Each cycle included flying the head on a track (at a constant disc radius) for ten seconds and sweeping the head between the inner and outer radius of the disc 108 for twenty seconds. The new head 118 was not burnished before beginning the test. In the first 100 cycles, a force transducer indicated that the head had contacted the disc surface several times. After 100 cycles, the head was burnished as described above with reference to FIG. 4 for 500 start/stop sequences. The test was then resumed for more than five days (30000 cycles) without any detected contact between the disc and the head. Accordingly, the method described above with reference to FIGS. 3 and 4 significantly decreases the number of contacts between the head and the disc during normal disc operation, thereby increasing the reliability and durability of the disc drive.

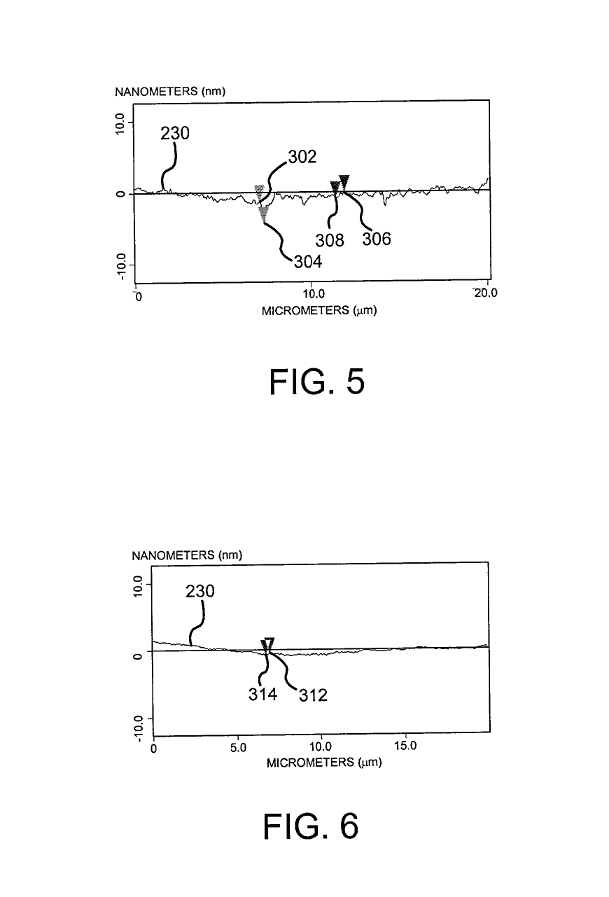

FIGS. 5 and 6 depict the surface contour of a surface portion 230 before and after burnishing in accordance with the present invention and demonstrate the decreased roughness of the head surface. In both figures, the vertical axis is a measure of the vertical position (normal to the surface portion 230 in the direction of arrow 300 in FIG. 2) of the surface portion 230 measured in nanometers (nm) and the horizontal axis is a measure of the horizontal position (along the surface portion 230 in the direction of arrow 301 in FIG. 2) of the surface portion 230 measured in micrometers (μm). The scale of FIGS. 5 and 6 is substantially the same.

To aid in analyzing the difference between the roughness of the surface in FIG. 5 and that of FIG. 6, adjacent upper and lower points were measured. Referring to FIG. 5, the horizontal distance between a first upper point 302 and an adjacent first lower point 304 of the surface portion 230 before burnishing was 234.38 nm while the vertical distance between the two points 302, 304 was 3.453 nm, yielding a surface angle of 0.844 degree relative to the horizontal axis. The surface between the first upper point 302 and the first lower point 304 appears to be the steepest incline of the surface portion 230 before burnishing. The horizontal distance between a second upper point 306 and an adjacent second lower point 308 of the surface portion 230 before burnishing was 546.88 nm while a vertical distance between the two points 306, 308 was 0.960 nm, yielding a surface angle of 0.101 degree relative to the horizontal axis.

The head was then burnished as described above in FIG. 4 for 250 start/stop sequences. Referring to FIG. 6, the horizontal distance between an upper point 312 and an adjacent lower point 314 of the surface portion 230 after burnishing was 234.38 nm while a vertical distance between the two points 312, 314 was 0.272 nm yielding a surface angle of 0.066 degree relative to the horizontal axis. The surface between the upper point 312 and the lower point 314 appears to be the steepest substantial incline of the surface portion 230 after burnishing. Therefore, the steepest incline angle before burnishing (0.844 degree) was more than ten times the steepest incline angle after burnishing (0.066 degree). This leads to the conclusion that the surface portion 230 was significantly smoother after burnishing than it was before and that asperities in the surface portion 230 were removed by the burnishing method. This conclusion was verified by calculating the roughness, Ra, of the surface portion 230 before and after burnishing. Ra is a value representing the average roughness across a line of the surface. A greater value of Ra represents a rougher surface. The roughness of the surface portion 230 before burnishing was 0.58 nm, while the roughness after burnishing was 0.37 nm.

In an alternative embodiment, the rotating step 244 of FIG. 3 is accomplished by continuously rotating the disc 108 with the head 118 remaining in the park zone 120. In this embodiment, rather than performing numerous start/stop sequences, the disc 108 is rotated at a predetermined speed for a selected time. Preferably in this embodiment, the disc 108 is rotated for between five and thirty minutes. The speed is preferably chosen to maximize the burnishing effect of the park zone 120 on the head 118. Preferably, the speed is below the normal operating speed of the disc drive 100, and even more preferably below the full take off speed of the disc drive 100 so that the head 118 remains in constant contact with the park zone 120. However, the speed may be above the take off speed and it may even be at the normal operating speed so long as the head 118 flies low enough to contact the bumps formed in the park zone 120.

In summary, an embodiment of the present invention is a method of contouring a surface portion (such as 230) of a head (such as 118) for a disc drive (such as 100) that includes a disc (such as 108) rotatably mounted on a base (such as 102). The method includes positioning (such as 242) the head over a park zone (such as 120) of the disc (such as 108) and rotating (such as 244) the disc (such as 108) for a selected time to burnish the head against the park zone of the disc while maintaining the head positioned substantially over the park zone.

The park zone may comprise a textured surface, which preferably includes bumps that interact with the surface portion of the head. The rotating step may include rotating the disc at a fixed rotational speed for the selected time. The fixed rotational speed may be less than an operating rotational speed of the disc, and is preferably less than a full take off speed of the drive. The rotating step preferably includes rotating the disc for a period of time of from about five minutes to about thirty minutes. Alternatively, the rotating step may include plural sequences of starting and stopping the disc. In a preferred embodiment, the rotating step includes from about 100 to about 500 starting and stopping sequences.

Alternatively, an embodiment of the present invention may be summarized as a disc drive (such as 100) including a disc (such as 108) rotatably mounted on a spindle motor (such as 106) mounted on a base (such as 102) and an actuator assembly (such as 110) mounted adjacent the disc, the actuator assembly having an actuator arm (such as 114) including a distal end supporting a head (such as 118) over a surface (such as 201) of the disc. The head includes a head surface portion (such as 230) facing the disc surface, wherein the head surface portion has been contoured by positioning the head over a park zone (such as 120) on the disc and maintaining the head positioned substantially over the park zone of the disc while rotating the disc for a selected tiem so as to burnish the head surface portion. In a preferred embodiment, the head surface portion preferably has a roughness of less than about 0.5 nanometers.

An embodiment of the present invention may also be summarized as a method of contouring the surface portion of the head for the disc drive that includes the disc rotatably mounted on the base. The method includes positioning the head over the park zone of the disc and contouring the head surface portion to reduce contact between the head and the disc during operation of the disc drive. The step for contouring may include rotating the disc at a fixed rotational speed for the selected time. Alternatively, the step for contouring may include plural sequences of starting (such as 252) and stopping (such as 254) rotation of the disc.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the speed of the disc rotation during burnishing could be sequentially increased and decreased without completely stopping the disc rotation. Numerous other changes may be made which will readily suggest themselves to those skilled in the art and which are encompassed in the spirit of the invention disclosed and as defined in the appended claims.

What is claimed is:

1. A method of contouring a surface portion of a head for a disc drive that includes a disc rotatably mounted on a base, the method comprising:
positioning the head over a park zone of the disc; and
rotating the disc for a selected time to burnish the head against the park zone of the disc while maintaining the head positioned substantially over the park zone.

2. The method of claim 1, wherein the park zone comprises a textured surface.

3. The method of claim 2, wherein the textured surface includes bumps that interact with the surface portion of the head.

4. The method of claim 1, wherein the rotating step includes rotating the disc at a fixed rotational speed for the selected time.

5. The method of claim 4, wherein the fixed rotational speed is less than an operating rotational speed of the disc.

6. The method of claim 5, wherein the fixed rotational speed is less than a take off speed of the head.

7. The method of claim 4, wherein the rotating step comprises rotating the disc for a period of time of from about five minutes to about thirty minutes.

8. The method of claim 1, wherein the rotating step includes plural sequences of starting and stopping the disc.

9. The method of claim 8, wherein the rotating step includes from about 100 to about 500 starting and stopping sequences.

10. A disc drive including a disc rotatably mounted on a spindle motor mounted on a base and an actuator assembly mounted adjacent the disc, the actuator assembly having an actuator arm including a distal end supporting a head over a surface of the disc, the head comprising:
a head surface portion facing the disc surface, wherein the head surface portion has been contoured by positioning the head over a park zone on the disc and maintaining the head positioned substantially over the park zone of the disc while rotating the disc for a selected time so as to burnish the head surface portion.

11. The disc drive of claim 10, wherein the head surface portion has a roughness of less than about 0.5 nanometers.

12. The disc, drive of claim 10, wherein the park zone comprises a textured surface defining a plurality of bumps that interact with the surface of the head as the head is burnished.

13. The disc drive of claim 12, wherein the disc is rotated at a fixed rotational speed for the selected time as the head is burnished.

14. The disc drive of claim 13, wherein the fixed rotational speed is less than an operating rotational speed of the disc drive.

15. The disc drive of claim 14, wherein the fixed rotational speed is less than a take off speed of the head.

16. The disc drive of claim 13, wherein the disc is rotated for a period of time of from about five minutes to about thirty minutes.

17. The disc drive of claim 12, wherein the disc undergoes a plurality of starting and stopping sequences as the head is burnished.

18. The disc drive of claim 17, wherein the plurality of starting and stopping sequences is between about 100 and about 500 sequences.

19. A method of contouring a surface portion of a head for a disc drive that includes a disc rotatably mounted on a base, the method comprising:
positioning the head over a park zone of the disc; and
contouring the head surface portion to reduce contact between the head and the disc during operation of the disc drive.

20. The disc drive of claim 19, wherein the contouring step comprises rotating the disc at a fixed rotational speed for a selected time.

21. The disc drive of claim 19, wherein the contouring step comprises plural sequences of starting and stopping rotation of the disc.
